(19) United States
(12) Patent Application Publication
(10) Pub. No.: US 2016/0156786 A1
(43) Pub. Date: Jun. 2, 2016

(54) MANAGEMENT METHOD OF ELECTRONIC EQUIPMENT

(71) Applicant: KYOCERA Document Solutions Inc., Osaka (JP)

(72) Inventor: Masayuki YAMASHIRODANI, Osaka (JP)

(73) Assignee: KYOCERA Document Solutions Inc., Osaka (JP)

(21) Appl. No.: 14/953,335

(22) Filed: Nov. 28, 2015

(30) Foreign Application Priority Data
Nov. 28, 2014 (JP) 2014-241797

(51) Int. Cl. H04N 1/00

(52) U.S. Cl. CPC H04N 1/00013; H04N 1/00029; H04N 1/00076; H04N 1/00087; H04N 1/0005; H04N 1/00039; H04N 2201/0094; H04N 2201/0091

(57) ABSTRACT

Provided is an electronic equipment and a management method of the electronic equipment able to alleviate dissatisfaction and a disadvantage inflicted on a user and an expense incurred by a manager until functions of a copier are recovered even when a failure is occurred. The electronic equipment includes a processing part that executes processing to be charged to a user; a control circuit that has a diagnosis function for diagnosing a failure when the failure interrupting the processing is occurred and a clocking function for clocking a first time taken for execution of the diagnosis function; and a memory part that has a counting region in which the number of execution of the processing clocked by the control circuit is held.

### INCORPORATION BY REFERENCE

This application is based on and claims the benefit of priority from Japanese Patent Application No. 2014-241797 filed on Nov. 28, 2014, the entire contents of which are hereby incorporated by reference.

### BACKGROUND

The present disclosure relates to an electronic equipment composed of plural processing units having a self-diagnosis function for detecting what sort of failure is occurred when a failure is occurred during the execution of copy processing.

Some copying machines (copiers) are configured by assembling plural units, such as an ADF (Auto Document Feeder) for automatically and continuously supplying a manuscript; a printer; an ASF (Automatic Sheet Feeder) for feeding a printing paper; a sorter for classifying (sorting) a printed matter (copied matter); and a control device (computer equipped with an operation panel or the like) for controlling these units.

Further, some electronic equipments including such a copier have a self-diagnosis function for detecting in which unit and what sort of failure is occurred when copy processing is interrupted during the execution of copy processing due to the occurrence of a failure.

Furthermore, some electronic equipments (control device included therein) are connected more than one to a communication network for controlling a state of each of the electronic equipments by a management device, and for efficiently recovering the electronic equipments from a failure in the event of the occurrence of the failure.

Some of these electronic equipments having the self-diagnosis function display a service call (requesting a manager to execute function recovery processing of copy processing), or leaves therein a log (record) accumulated during the execution of the self-diagnosis.

Once a failure occurs, however, the electronic equipment falls into a situation where the electronic equipment will become unavailable from the time when the electronic equipment detects by the self-diagnosis function what kind of failure is occurred to the time when a copy processing function is recovered therefrom. It has been a factor of dissatisfaction of a user due to this. Further, supply of operating power to the electronic equipment is naturally required even during the self-diagnosis, and thus could inflict a disadvantage on a user from the point of view of power consumption.

Moreover, it has been routinely performed that a manager's side (serviceman at manager's side) immediately rushes over to a user or an installation location of the electronic equipment where the serviceman compensates a loss suffered from maintenance of the electronic equipment to alleviate dissatisfaction and disadvantage of a user. However, compensating the loss will lead to a loss and dissatisfaction of the manager's side without question and beyond doubt.

### SUMMARY

An electronic equipment includes a processing part that executes processing to be charged to a user; a control circuit that has a diagnosis function for diagnosing a failure when the failure interrupting the processing is occurred and a clocking function for clocking a first time taken for executing the diagnosis function; and a memory circuit that has a counting region in which the number of execution of the processing counted by the control circuit is held, the control circuit executing compensation processing according to the first time after the execution of the diagnosis function.

Further, an electronic equipment includes a processing part that executes processing to be charged to a user; a control circuit that has a diagnosis function for diagnosing a failure when the failure interrupting the processing is occurred and a clocking function for clocking a first time taken for executing the diagnosis function; and a memory circuit that has a counting region in which the number of execution of the processing counted by the control circuit is held, the control circuit executing compensation processing according to the first time after the execution of the diagnosis function.

Moreover, a management method of an electronic equipment having a processing part that executes processing to be charged to a user, a control circuit that has a diagnosis function diagnosing a failure when the failure interrupts the processing is occurred and a clocking function clocking a first time taken for executing the diagnosis function, and a memory circuit that has a counting region in which the number of execution of the processing counted by the control circuit is held, the method comprising a step of executing compensation processing according to a first time after the execution of the diagnosis function by the control circuit.

### BRIEF DESCRIPTION OF THE DRAWINGS

FIG. 1 is an external view showing an external appearance of a MFP1 to which the present disclosure is applied;

FIG. 2 is a block diagram showing a configuration of a control system of the MFP1 according to the present disclosure;

FIG. 3 is a view explaining an application mode of the MFP1 according to the present disclosure;

FIG. 4A is a view showing an example of a message to be displayed on a display panel 61 during the execution of copy processing according to the present disclosure;

FIG. 4B is a view showing an example of a message to be displayed on the display panel 61 during the execution of copy processing according to the present disclosure;

FIG. 4C is a view showing an example of a message to be displayed on the display panel 61 during the execution of copy processing according to the present disclosure;

FIG. 5A is a chart diagram showing a flow from the time when self-diagnosis is started to the time when copy processing is restarted when a failure is occurred during the execution of copy processing according to the present disclosure;

FIG. 5B is a chart diagram showing a flow from a start of self-diagnosis to a restart of copy processing when a failure is occurred during the execution of copy processing according to the present disclosure;

FIG. 5C is a chart diagram showing a flow from a start of self-diagnosis to a restart of copy processing when a failure is occurred during the execution of copy processing according to the present disclosure;

FIG. 6A is a view showing an example of a message to be displayed on the display panel 61 during the execution of copy processing according to the present disclosure;

FIG. 6B is a view showing an example of a message to be displayed on the display panel 61 during the execution of copy processing according to the present disclosure;

FIG. 6C is a view showing an example of a message to be displayed on the display panel 61 during the execution of copy processing according to the present disclosure;

FIG. 7A a view showing an example of a message to be displayed on the display panel 61 during the execution of copy processing according to the present disclosure;

FIG. 7B is a view showing an example of a message to be displayed on the display panel 61 during the execution of copy processing according to the present disclosure; and

FIG. 7C is a view showing an example of a message to be displayed on the display panel 61 during the execution of copy processing according to the present disclosure.

### DETAILED DESCRIPTION

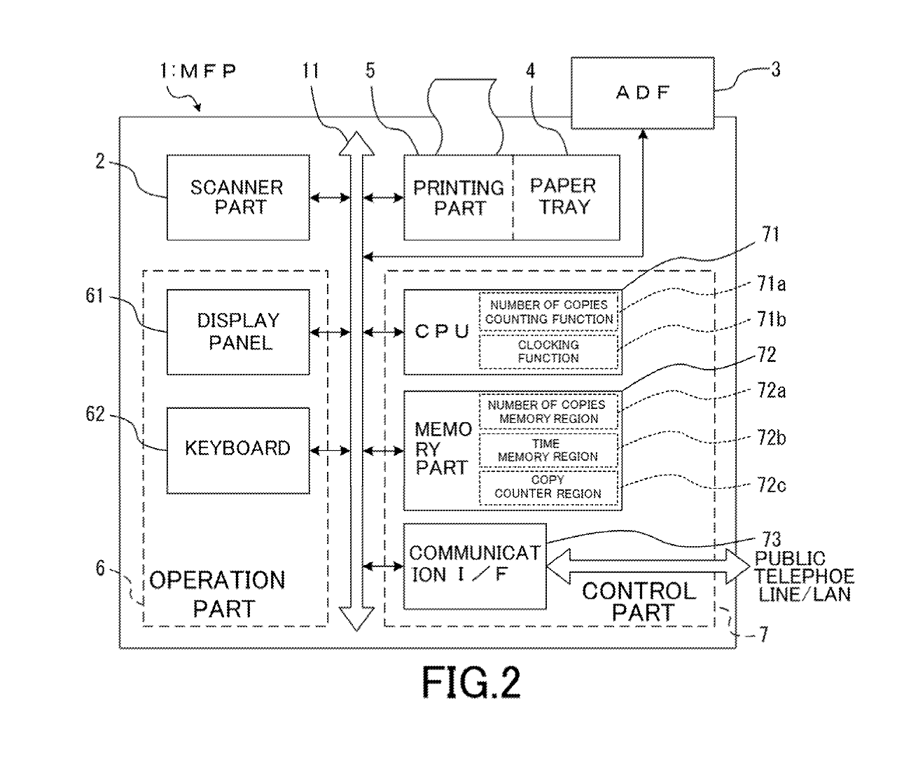

Hereinafter, an exemplary embodiment of the present disclosure will be specifically described with reference to the accompanying drawings. Throughout the drawings, the same component shall be denoted by the same reference character. By way of example, the present disclosure is applied to a MFP1 (Multi Function Peripheral) 1, as shown in the block diagram of FIG. 2.

The MFP1 is provided on its upper part with a scanner part 2 for reading out an image of a manuscript. Also, the scanner 2 is provided on its upper part with an ADF 3 for automatically feeding a manuscript.

The scanner is provided with an operation part 6 having a display panel 61 and a keyboard 62 in the vicinity (for example, front part) of an upper part thereof. Further, the operation part 6 is provided inside thereof a control part 7.

The control part 7 is composed of a CPU (Central Processing Unit) 71, a memory part 72, and a communication I/F (interface) 73.

The CPU 71 has a number counting function 71a and a clocking function 71b. The number counting function 71a is for counting the number of a printed matter (to be described later) after a start of copy processing of a manuscript. The clocking function 71b is for clocking a time during the execution of self-diagnosis to be described later.

The memory part 72 is composed of a volatile memory device such as a RAM (Random Access Memory) and a non-volatile memory device such as a flush memory and a HDD (Hard Disk Drive).

Further, the memory part 72 has a region for storing a control program controlling the entire MFP1 and a region for converting an image read out from a manuscript into data and store it temporally or for a long time. Other than the above, the memory part 72 has a number of copies storing region 72a, a time storing region 72b, and a copy counter region 72c in the non-volatile memory device part. The I/F 73 is connected to a public telephone line and a LAN (local Area network) and is for transmitting and receiving a facsimile and information between a user and a manger to be described later.

The above-mentioned number of copies storing region 72a is a region for storing a value counted by the number counting function 71a before a start of self-diagnosis when a failure is occurred.

The time storing region 72b is for storing a time clocked by the clocking function 71b and for holding the time taken for the execution of self-diagnosis. It is assumed here that power supply is assured by a battery or the like, even when the power supply to the MFP1 is abruptly cut off during the execution of self-diagnosis, and a value is stored in the time storing region 72b every time the value clocked by the clocking function 71b is changed (for example, every 1 sec). This enables the time taken for self-diagnosis to hold in the time storing region 72b even when the power supply to the MFP1 is abruptly cut off.

The copy counter region 72c is a region for holding a counter value constituting the base of calculation of a usage fee (to be described later) of the MFP1.

A paper tray 4 is provided beneath the MFP1 and a printing part 5 is provided at the middle part of the MFP1.

The paper tray 4 is for storing recording papers in a draw-out container, as an example. The paper tray 4 has a configuration in which the recording papers are lifted up and a sheet of the recording papers is drawn out from the recording papers stored in the paper tray 4.

The printing part 5 is for recording (printing) an image on a recording paper drawn out from the paper tray 4. The paper tray 4 is composed of a light emitting part, an exposing part, and plural rollers, as an example.

A printed matter on which an image is printed by the printing part 5 is discharged into a discharging tray 55 positioned above the paper tray 4.

As shown in FIG. 2, each part mentioned above is connected to a bus 11. The CPU 71 executes various processing to control each part based on a control program stored in the memory part 72.

Each part is also provided with a sensor and an electronic circuit or the like, for self-diagnosis. Thus, the control part 7 detects in which part and what sort of failure is occurred in the MFP1.

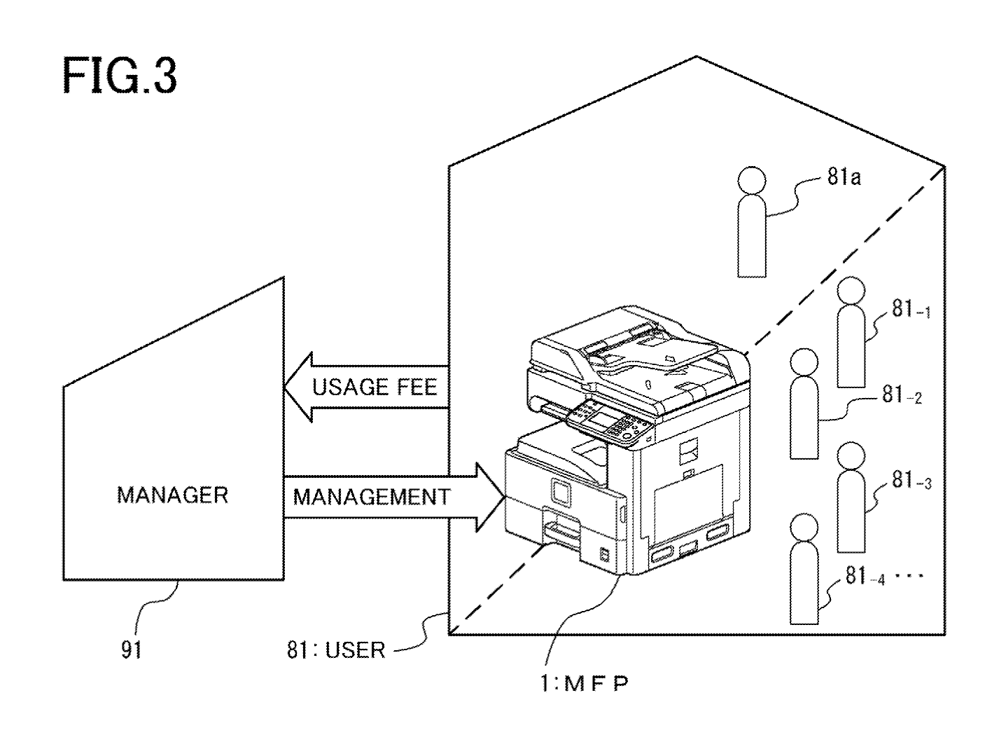

As shown in FIG. 3, as a premise of carrying out the present disclosure, a user 81 uses the MFP1 managed by a manager 91. In this connection, the management as used herein means to owe the MFP1 or to entrust maintenance, inspection, and repair etc. of the MFP1 to the manager 91.

The user 81 may be an individual user 81a or a group consisting of plural user 81₋₁, 81₋₂, 81₋₃, 81₋₄. . . .

Although the MFP1 may be shared by an individual user 81a, and a group consisting of plural users 81₋₁,81₋₂, 81₋₃,81₋₄, a description shall be made here collectively with all of them as the user 81 for convenience of explanation.

Meanwhile, the manager 91 may also be an individual or a group, and a similar manager may exist more than one person. Nevertheless, a description will be made here on the assumption that managing one MFP1 by two or more managers would be highly improbable.

Moreover, it is assumed in the present disclosure that an application mode is applied such that when the user 81 copies a manuscript by the MFP1, the electronic equipment accumulates a usage fee to be incurred one by one for a copied matter (printed matter in which an image read out from the scanner part 2 is printed on a recording paper by the printing part 5), and the user 81 pays the accumulated usage fee to the manager 91 for every prescribed period.

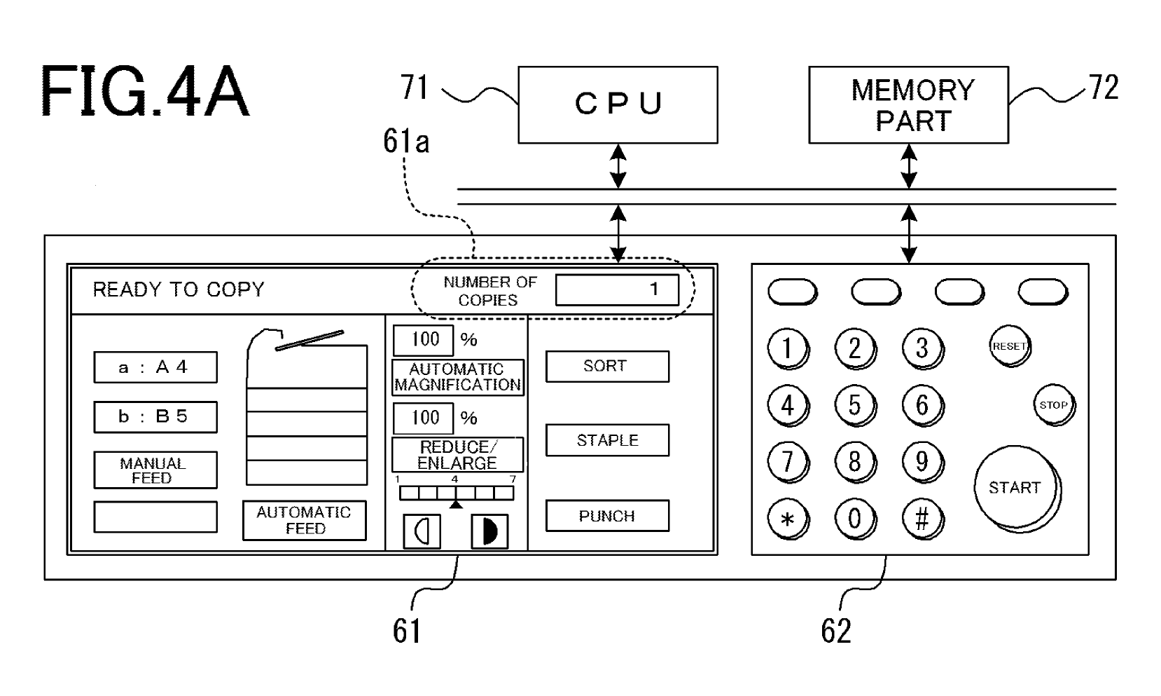

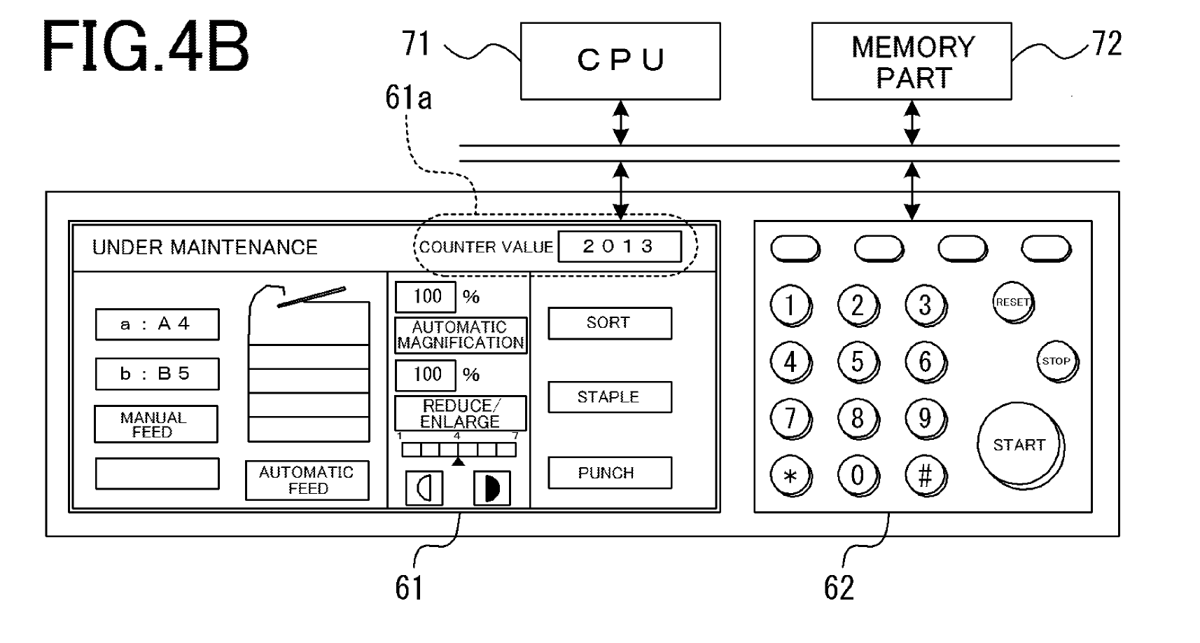

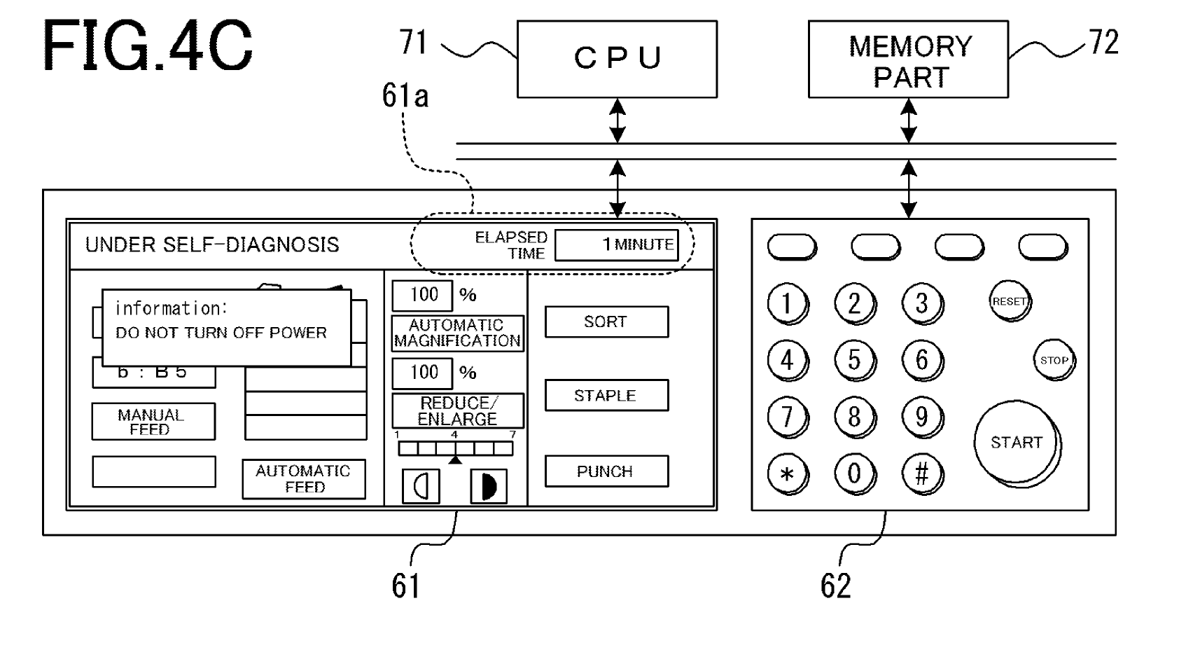

As shown in FIG. 4, in the case of such application mode, the CPU 71 displays a massage such as “ready for copy” on a display panel 61 and the number of copy per one manuscript on the region 61a under a state where the MFP1 is operating normally (a waiting state of an instruction to start copy processing).

The CPU 71 adds a predetermined number to a counter value stored in the copy counter region 72c every time copy processing is executed. In this connection, the predetermined number is set depending on a difference in the size of paper and in monochrome printing or color printing.

When a failure is occurred, for example, that a printed matter is not discharged from the printing part 5 during the execution of copy processing by the MFP1 according to the present embodiment (a sensor for sensing the passage of a printed matter is provided at a discharging part of the printing part 5), the control part 7 interrupts first automatic supply of a manuscript by the ADF 3 and reading out of a manuscript by the scanner part 2. Subsequently, the control part 7 executes self-diagnosis.

When a printed matter is not discharged, the self-diagnosis is executed to the following items. Namely, an inspection is made by a sensor provided in the paper tray 4 and the printing part 5 to determine whether or not a recording paper or a printed matter is staying somewhere on a discharging route from the paper tray 4 to the printing part 5; whether or not a recording paper can draw out from the paper tray 4; and whether or not a recording paper is conveyed normally within the printing part 5.

Herein, to determine whether or not a recording paper is conveyed normally within the printing part 5, it may sometimes need to check whether or not plural rollers are rotated for each of the rollers. Accordingly, it is not uncommon for self-diagnosis to take a long time. Further, it may sometimes take a long time for self-diagnosis due to logging of data during the execution of self-diagnosis.

As shown in FIG. 4C, when the self-diagnosis taking a long time is executed, the CPU 71 displays a massage of “under self-diagnosis” on the display panel 61, and at the same time displays an elapsed time from a start of the self-diagnosis on the region 61a. This enables the user 81 to know that the MFP1 is under self-diagnosis.

In the present disclosure, the MFP1 that is an electronic equipment automatically makes determination whether or not convenience of the user 81 is impaired to a trouble that a long time is spend for the self-diagnosis and convenience of the user 81 is impaired. The MFP1 automatically presents the user 81 the need or not of compensation, or prompts the user 81 to select a type of compensation depending on a determination result.

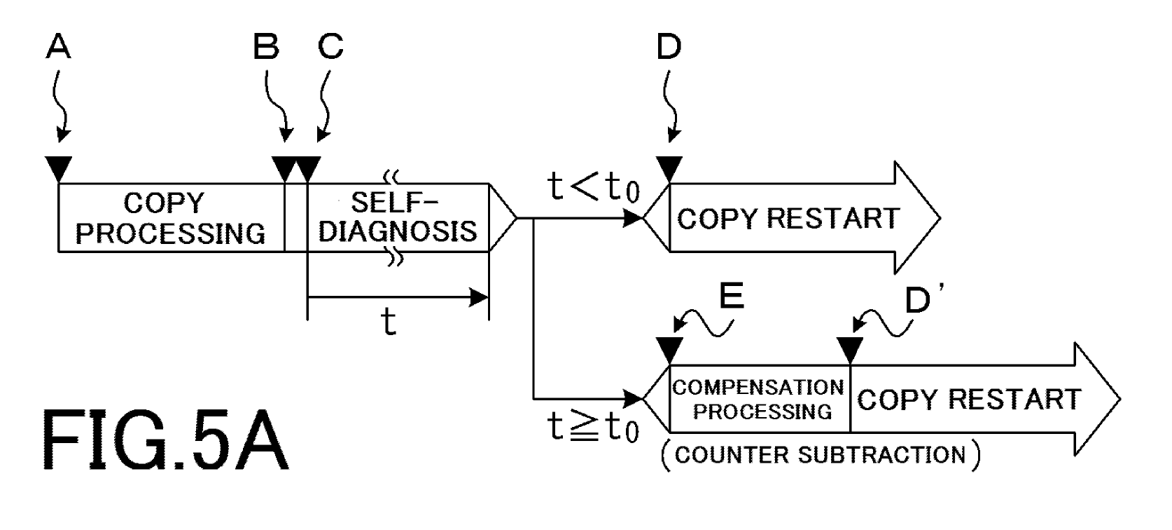

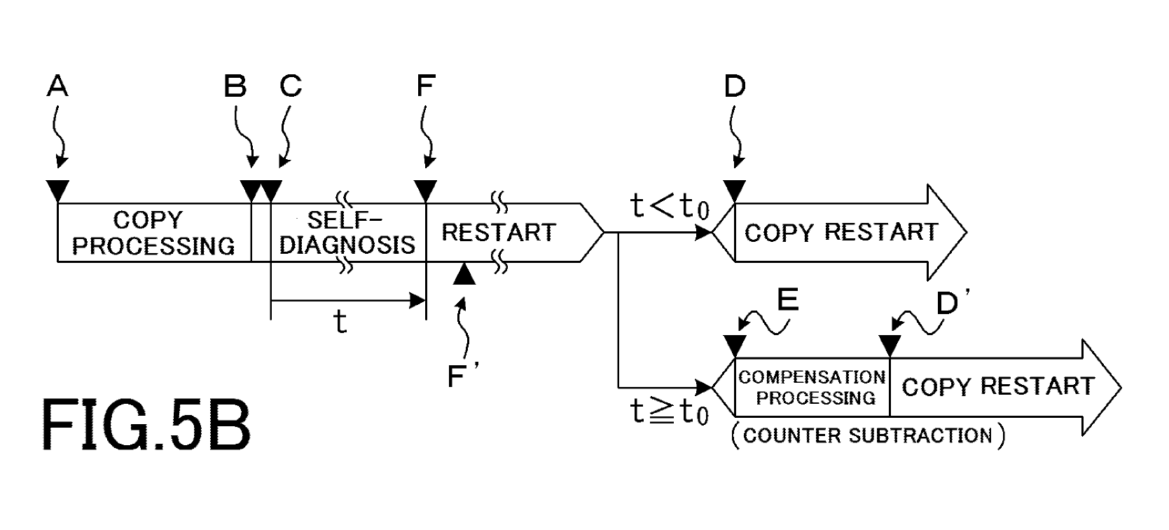

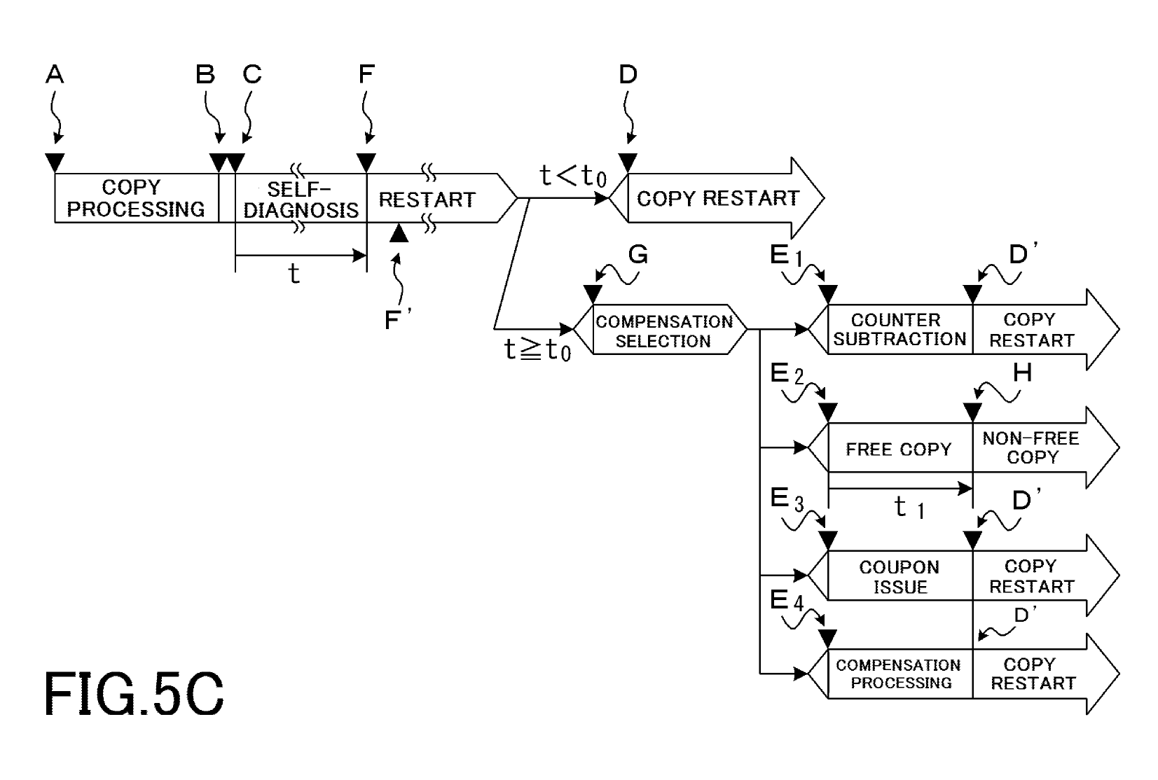

A flow from the time when a failure is occurred in the MFP1 according to the present embodiment during the execution of copy processing to the time when the copy processing is restarted by executing self-diagnosis is shown in FIGS. 5A to 5C. Here, FIG. 5A corresponds to a first embodiment, FIG. 5B corresponds to a second embodiment, and FIG. 5C corresponds to a third embodiment, respectively. Each of them will be detailed later.

### FIRST EMBODIMENT

In the first embodiment, a flow from the time when a failure is occurred to the time when copy processing is restarted by executing compensation processing is shown in FIG. 5A. As shown in FIG. 5A, the first embodiment is intended for determining whether or not the compensation processing is executed depending on a time taken for self-diagnosis.

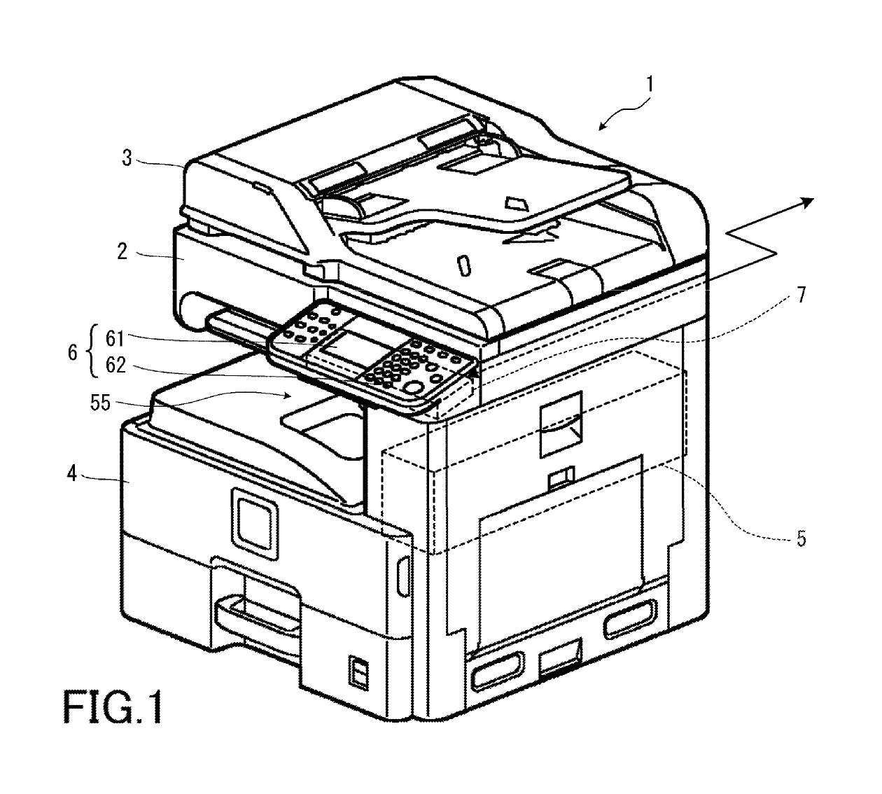

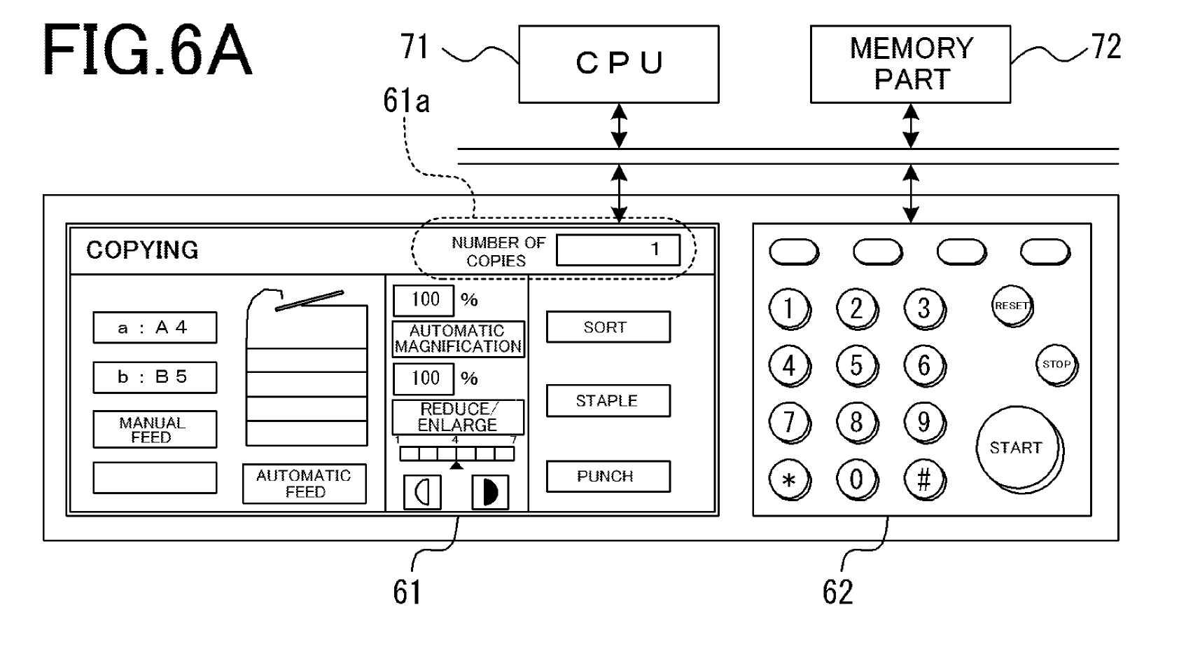

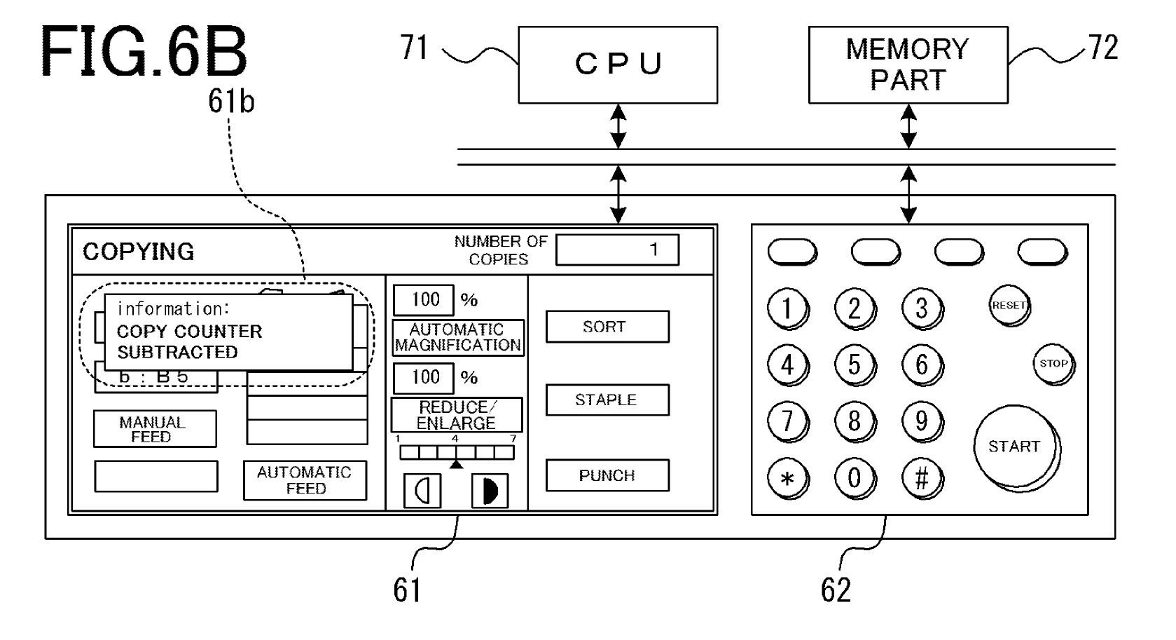

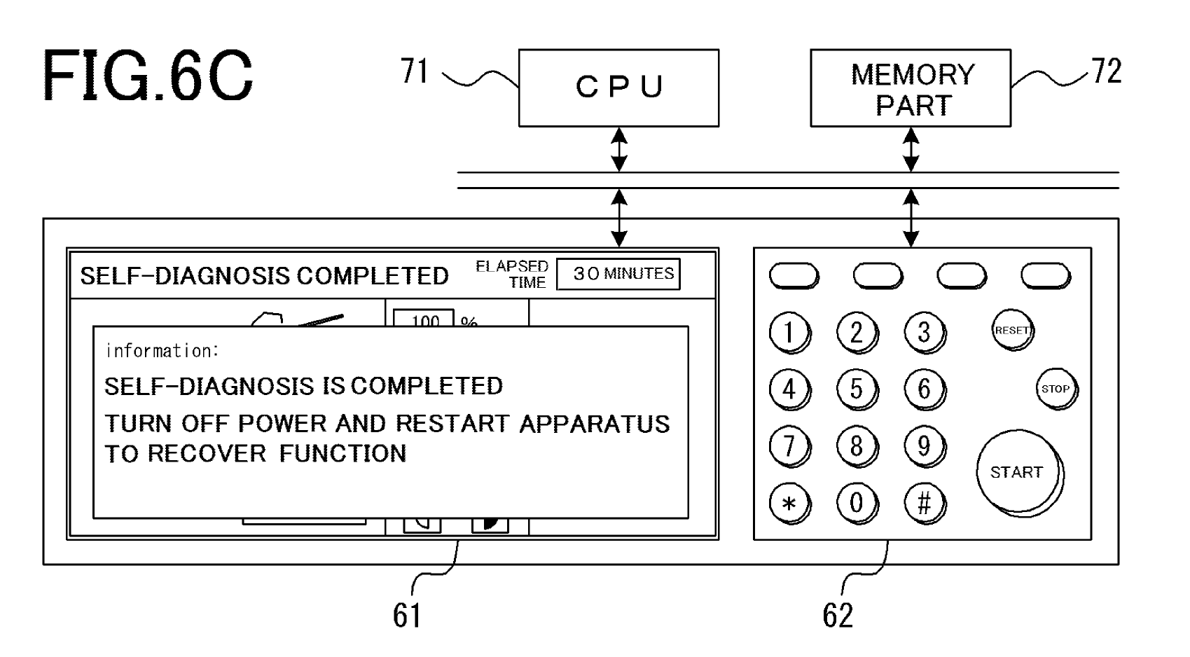

Referring to FIG. 5A, copy processing is started at a point of time A. This copy processing is started by placing a manuscript on the ADF 3 by the user 81, and by operating a keyboard 62 (depress a start key) (for configuration of the MFP1 or the like, see FIG. 1 to FIG. 4 or FIG. 4C). As shown in FIG. 6A, during the execution of copy processing, the CPU 71 displays a message of “copying” on the display panel 61, and at the same time counts by the number counting function 71a the number of copies of a printed matter to be discharged.

When a failure is occurred at a point of time B, the control part 7 writes a counted number by the number counting function 71a in the number of copies storing region 72a. Subsequently, the control part 7 terminates processing such as discharge of an already read manuscript and discharge of a printed recording paper, and starts self-diagnosis at a point of time C. As shown in FIG. 4C, when self-diagnosis is started at the point of time C, the control panel 7 displays a message on the display panel 61, and at the same time clocks an elapsed time from the time when the self-diagnosis is started by the clocking function 71b. The time taken for the execution of self-diagnosis is set as a time t (first time).

After the self-diagnosis is completed, comparison is made between the time t taken for self-diagnosis and a reference time t₀ (for example, a few minutes to several tens of minutes) previously set as a criterion to determine whether or not compensation processing should be executed. If the time t is less than the reference time t₀, copy processing is restarted at a point of time D (if no manuscript is placed on the ADF3, the processing is ended without executing copy processing) .

Otherwise, if the time t is more than the reference time t₀, compensation processing is executed at a point of time E. As an example of the compensation processing, suppose here that the time taken for self-diagnosis is t minutes, the t minutes are subtracted from a counter value of the copy counter region 72c. After the compensation processing is executed at the period of time E, copy processing is restarted at a point of time D′.

If the copy processing is restarted at the point of time D′, the control panel 7 displays a message of “copy counter is subtracted” such as the region 61b shown in FIG. 6B until another manuscript is placed on the ADF 3 and next copy processing is started. At this moment, it may notify the user 81 that the compensation processing is executed as a long time has taken for self-diagnosis.

### SECOND EMBODIMENT

In the second embodiment, a flow from the time when a failure is occurred to the time when copy processing is restarted by executing compensation processing is shown in FIG. 5B. As shown in FIG. 5B, the second embodiment is intended for executing restart processing to restore the electronic equipment to a previous state at which no failure is occurred after the execution of self-diagnosis. Here, processing from the point of time A to the point of time E are the same as those of the first embodiment, and thus a detailed description thereof is omitted for the sake of brevity.

The second embodiment is focused on a case where the time at a period of time C is extremely long as compared with that of the first embodiment (for example, the time t amounts to several tens of minutes) and a case where of replacement of consumables is required as a result of the self-diagnosis.

After the execution of self-diagnosis, restart processing is executed at a point of time F for each of the parts composing the MFP1 to restore to a previous state where no failure is occurred.

It should be noted that power supply to the MFP1 is forced to shut off once for the reason that the control part 7 (CPU 71) should be initialized. In such a case, as shown in FIG. 6C, a message of prompting the user 81 to do an operation is displayed on the display panel 61, and the user 81 waits for the MFP1 to restart at a period of time F′.

After the MFP1 is restarted, comparison is made between the time t taken for self-diagnosis and the reference time t₀. If the time t is less than the reference time t₀, copy processing is restarted at a point of time D.

Otherwise, if the time t is more than the reference time t₀, compensation processing to subtract the time t from a counter value of the copy counter region 72c is executed at a point of time E, and copy processing is restarted at a point of time D′.

### THIRD EMBODIMENT

In the third embodiment, a flow from the time when a failure is occurred to the time when copy processing is restarted by executing compensation processing is shown in FIG. 5C. As shown in FIG. 5C, the third embodiment is intended for giving the user 81 freedom to select a compensation item after restarting. Here, processing from the point of time A to the point of time D, the point of time D′, and the point of time F are the same as those of the second embodiment, and thus a detailed description thereof is omitted for the sake of brevity.

In the third embodiment, comparison is made between the time t taken for self-diagnosis and the reference time t₀ after the MFP1 is restarted. If the time t is less than the time t₀, copy processing is restarted at a period of time D.

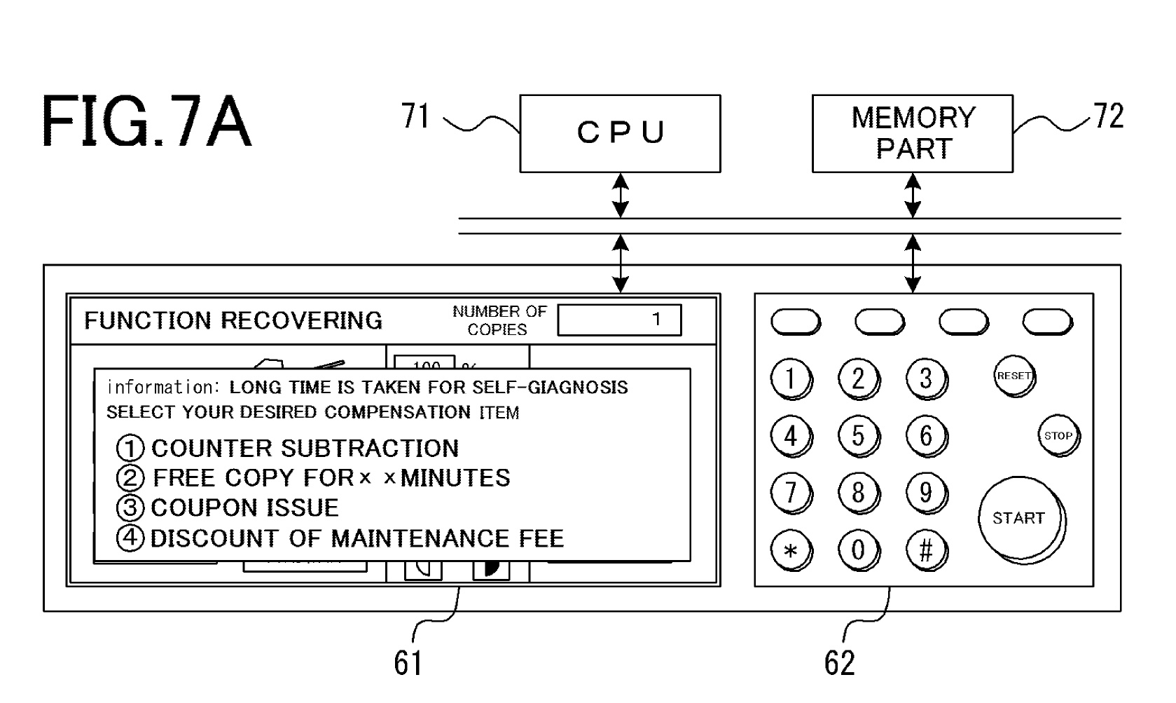

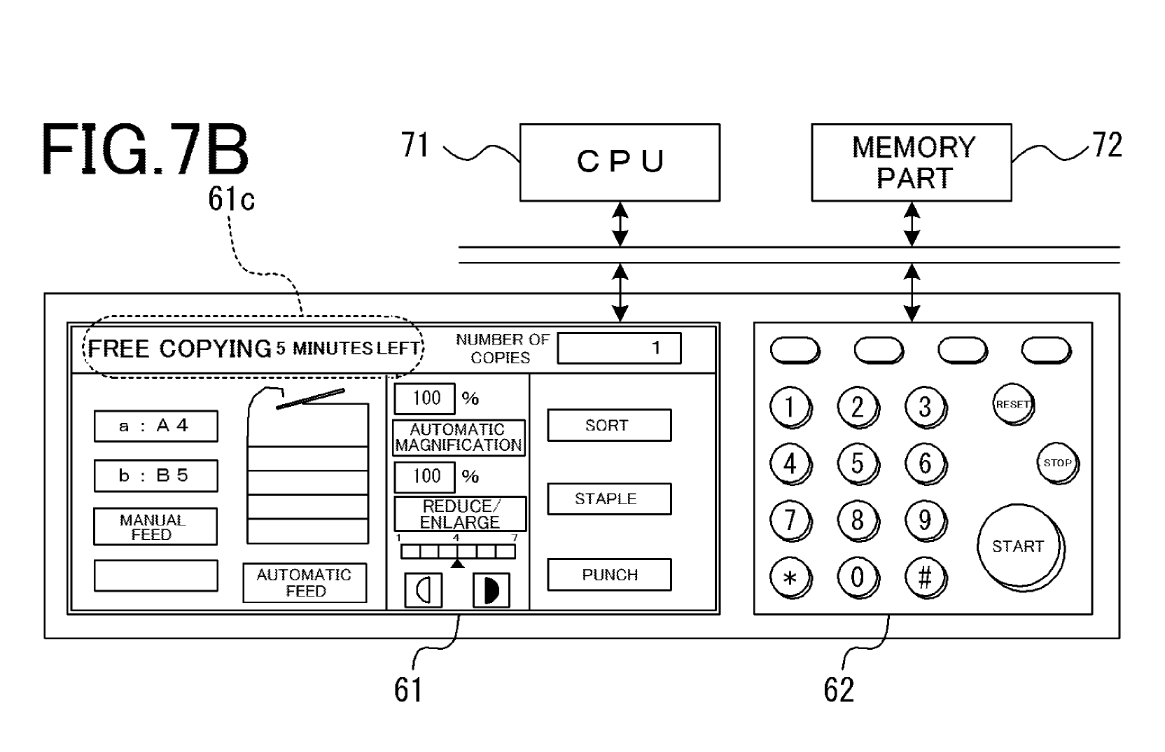

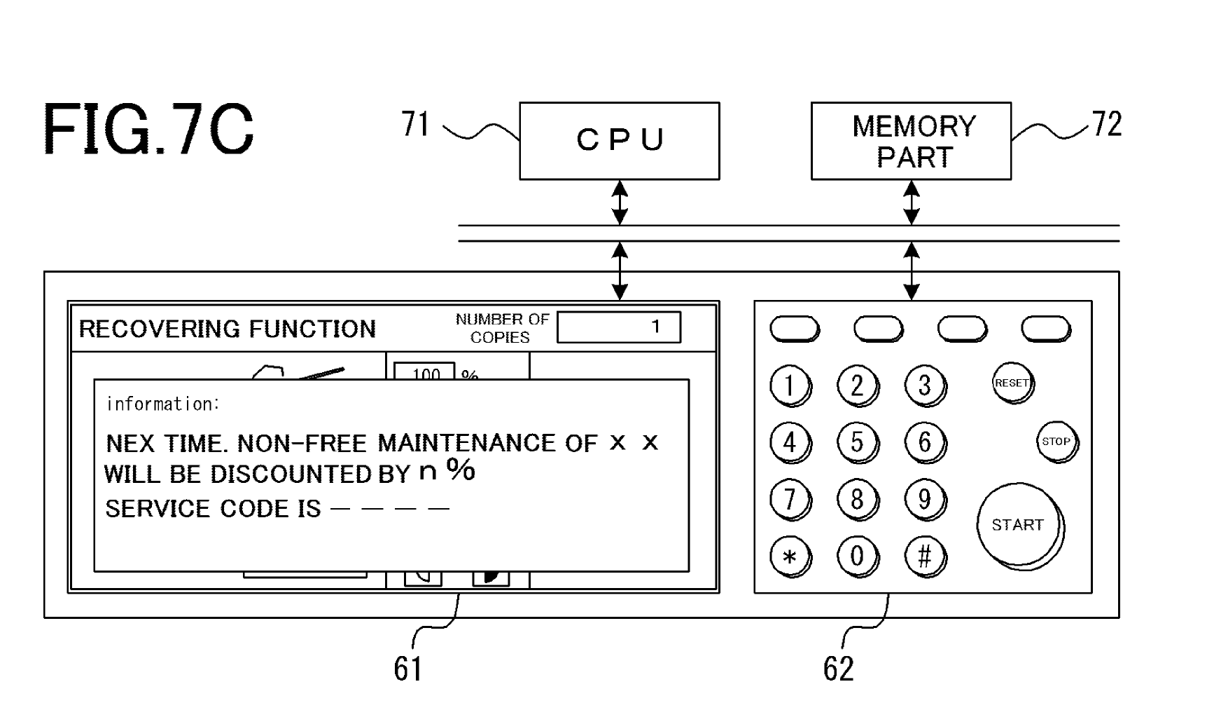

Otherwise, if the time t is more than the reference time t₀, as shown in FIG. 7A, the control part 7 displays a message of prompting the user 81 to select a compensation item on the display panel 61 at a period of time G, and waits for the user 81 to select a compensation item via the keyboard 62 or the like.

In the present embodiment, the compensation items are provided as options, such as “E₁: subtraction of counter” , “E₂: free copy for predetermined period of time” , “E₃: issue of coupon”, and “E₄: discount of non-free maintenance fee (compensation processing)”. Other than the above, it may provide alternative options such as “compensation is not required” and “select later”.

If the user 81 selects the “E₁: subtraction of counter” at a point of time G, as shown in FIG. 5C, subtraction of the counter is executed at a period of time E. The subtraction of the counter is the same as that of the period of time E shown in FIGS. 5A, 5B. If the time taken for self-diagnosis is t minutes, the t minutes are subtracted from a counter value of the copy counter region 72c. After the compensation processing is executed at the period of time E₁, copy processing is restarted at a period of time D′.

If the user 81 selects the “E₂: free copy for predetermined period of time” at a point of time G, as shown in FIG. 7B, the control part 7 displays a message of being under execution of free copy and a remaining time of the free copy in the region 61c of the display panel 61 at a period of time E₂ (see FIG. 5C). During the execution of the free copy, a counter value of the copy counter region 72C is not subtracted until the remaining time reaches 0.

At the period of time E₂, a predetermined ratio (for example, 10%) accounting for the time t taken for the self-diagnosis at the end of self-diagnosis is taken as a t1 (second time). Then, the time t1 is set to the clocking function 71b and the t1 is subtracted only while executing copy processing. In other words, the user 81 is permitted to execute for free the copy processing for the time t1.

If all the copy processing of manuscripts placed on the ADF3 is completed before the time t1 set to the clocking function 71b reaches 0, the time t1 is not subtracted until another manuscript is placed on the ADF 3 and the copy processing is started. This guarantees the user 81 to execute for free the copy processing for the time t1.

At the point of time E₂, as soon as the time t1 of the clocking function 71b reaches 0, the processing transitions to non-free processing at a point of time H. The processing H is the same as the processing D, and thus a description thereof is omitted for the sake of brevity.

If the user 81 selects the “E₃: issue of coupon” at a point of time G, a coupon is printed by the printing part 5 at a point of time E₃. As an example, a bar cord indicative of the number of coupon and a list of a discount rate, services, and consumables to be discounted. After the coupon is issued at the point of time E₃, copy processing is restarted at the period of time D′.

If the user 81 selects “E₄: discount of non-free maintenance fee” at the period of time G, as shown in FIG. 7C, the control part 7 displays a message indicative of discounting non-free maintenance fee on the display panel 61 at a period of time E₄, and copy processing is restarted at the period of time D′.

According to each of the embodiments of the present disclosure, comparison is made between the time taken for self-diagnosis and the reference time when a failure is occurred during the execution of copy processing in the electronic equipment such as the multifunction machine, and the self-diagnosis is executed. If the time taken for self-diagnosis is more than the reference time, the present disclosure enables a manager to execute compensation processing without rushing over to a user or to an installation location, and a user to prompt to select a compensation item. This alleviates dissatisfaction, a disadvantage inflicted on the user, and an expense incurred by the manager.

It is quite apparent that the present disclosure is not necessarily limited to each of the embodiments, and each of the embodiments may be appropriately modified within the technical idea of the present disclosure.

What is claimed is:

1. An electronic equipment comprising:
a processing part that executes processing to be charged to a user;
a control circuit that has a diagnosis function for diagnosing a failure when the failure interrupting the processing is occurred and a clocking function for clocking a first time taken for executing the diagnosis function; and
a memory circuit that has a counting region in which the number of execution of the processing counted by the control circuit is held,
the control circuit executing compensation processing according to the first time after the execution of the diagnosis function.

2. The electronic equipment according to claim 1, wherein the control circuit subtracts the number of execution of the processing held in the counting region when the first time exceeds a predetermined reference time after the execution of the diagnosis function.

3. The electronic equipment according to claim 1, wherein the control circuit restarts the discontinued processing after the execution of the diagnosis function, and calculates a second time accounting for a predetermined ratio of the first time when the first time exceeds the predetermined reference time, and stops the counting of the number of execution of the processing until the second time elapses.

4. The electronic equipment according to claim 1, wherein the processing part includes a reading part that reads out an image of a manuscript and a printing part that prints an image equivalent to the image read out on a recording paper, and adds the number of execution every time processing for copying the image of the manuscript is copied on the recording paper.

5. An electronic equipment comprising:
a processing part that executes processing to be charged to a user;
a control circuit that has a diagnosis function for diagnosing a failure when the failure interrupting the processing is occurred and a clocking function for clocking a time taken for executing the diagnosis function;
a memory circuit that has a counting region in which the number of execution of the processing counted by the control circuit is held ;
a display part that displays various information to the user by the control circuit; and
an input part that inputs various instructions to the control circuit by the user,
wherein the control circuit displays on the display part one or more compensation items to be compensated according to the time counted by the counting function, and executes a compensation item selected from the one or more compensation items via the input part by the user.

6. A management method of an electronic equipment having
a processing part that executes processing to be charged to a user,
a control circuit that has a diagnosis function diagnosing a failure when the failure interrupts the processing is occurred and a clocking function clocking a first time taken for executing the diagnosis function, and
a memory circuit that has a counting region in which the number of execution of the processing counted by the control circuit is held,
the method comprising a step of
executing compensation processing according to a first time after the execution of the diagnosis function by the control circuit.

7. The management method of the electronic equipment according to claim 6, further comprising a step of subtracting the number of execution of the processing held in the clocking region when the first time exceeds a predetermined reference time after the execution of the diagnosis function by the control circuit.

8. The management method of the electronic equipment according to claim 6, further comprising steps of restarting the interrupted processing after the execution of the diagnosis function, calculates a second time accounting for a predetermined ratio of the first time when the first time exceeds the predetermined reference time by the control circuit, and stopping the counting of the number of execution of the processing until the second time elapses.
